(19) United States
(12) Patent Application Publication
(10) Pub. No.: US 2003/0014745 A1
(43) Pub. Date: Jan. 16, 2003

(54) Document update method

(76) Inventors: John M. Mah, Calgary (CA); Michael Crew, Edmonton (CA)

Correspondence Address: Orange & Chari, P.O. Box 190, 66 Wellington St. W., Suite 4900, Toronto, ON, M5K 1H6, CA

(21) Appl. No.: 10/177,675

(22) Filed: Jun. 24, 2002

Related U.S. Application Data
(60) Provisional application No. 60/299,790, filed on Jun. 22, 2001.

(30) Foreign Application Priority Data
Jun. 22, 2001 (CA) 2,351,249

(51) Int. Cl. G06F 9/44

(52) U.S. Cl. 717/170

(57) ABSTRACT

This invention provides a method for updating a document module for use with an application program on a remote computer from a host computer. The method includes the steps of creating a document module and storing the document module at a resource center, associating the document module with a time-dependent unique identifier. The method includes the further steps of comparing the time dependent unique identifier associated with the document module at the remote device to the identifier at the resource center, and transmitting the document module at the resource center when the version on the remote computer is superseded.

### FIELD OF INVENTION

The present invention relates to software support, more particularly it relates to a method of updating application program modules on a computer.

### BACKGROUND OF THE INVENTION

At present there exists a plurality of methods for updating software applications or application components on a computer system. Traditional methods include floppy disk or CD-ROM distribution to end-users. However, with the advent of the Internet there has been widespread acceptance of updating software via the World Wide Web (WWW) or via file transfer protocol (FTP). The software update files or patches maybe transmitted from a central resource location, such as a server, to a remote computer via a dial-up modem connection.

However, in small to medium enterprises (SMEs) there is a need to update specific files, such as templates or forms for use by enterprise users, in these circumstances the application is not upgraded. In most cases these files are usually relatively small in size, typically less than one megabyte (MB), and may not warrant the storage capacity of CD-ROMs or CD-Rs of 650 MB or more. Therefore the above mentioned traditional methods may be cumbersome and time consuming, and in some cases, this may require additional hardware such as a CD-ROM drive. Also, in some instances such as financial statements revisions made to one document have impact on other documents such as charts or reports as the documents are often related. Therefore, the procedure of updating every related document to reflect any changes in a particular document may be relatively time consuming and prone to error in some cases.

It is therefore an object of this invention to mitigate at least one of the disadvantages.

### SUMMARY OF THE INVENTION

In one of its aspects, the present invention provides a method for updating document modules for use with a plurality of application programs. The method includes the steps of creating a document module and storing the document module at a resource center, associating the document module with a time-dependent unique identifier, transmitting the document module to a remote computer for use within the application program. The method may further include the step of automatically updating a document module at the remote computer. The steps include comparing the time dependent unique identifier associated with the document module at the remote device to the identifier at the resource center, and transmitting the document module at the resource center when the version on the remote computer is superseded.

In the preferred embodiment, the resource center maintains a plurality of document modules, and the resource center communicatively coupled to a plurality of remote computers. The resource center includes a version administrator for creating and revising the document modules in accordance with the functions afforded by an add-on software module associated with the application program. At the remote computer there is provided a version manager for checking the module version information and for comparing the version information before initiating the update of the document module at the remote computer in accordance with the functions afforded by the add-on software module. Generally, the version manager is a user at the remote computer.

### BRIEF DESCRIPTION OF THE DRAWINGS

These and other features of the preferred embodiments of the inventor will become apparent in the following defined description in which reference is made to the appended drawings wherein:

FIG. 1 is a system for updating document modules;

FIG. 2 shows a flow diagram outlining the invention or updating of a financial statement module at resource center;

FIG. 3 shows a flow diagram outlining the steps for updating a financial statement module at the remote computer;

FIG. 4 shows a flow diagram outlining the steps for updating a working paper module at the host computer;

FIG. 5 shows a flow diagram outlining the steps for updating a working paper module at the remote computer;

FIG. 6 shows a flow diagram outlining the steps for updating a note module at the host computer; and

FIG. 7 shows a flow diagram outlining the steps for updating a note module at the remote computer.

### DESCRIPTION OF THE PREFERRED EMBODIMENTS

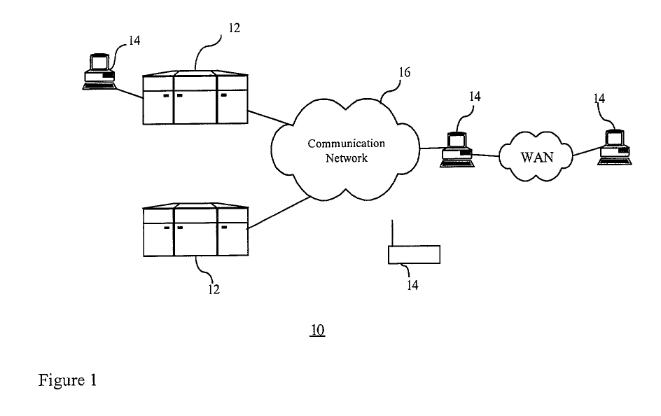

Reference is first made to FIG. 1, which is an overview of a system for facilitating a method for updating document modules, shown generally by the numeral 10, in a preferred embodiment. The system 10 includes a resource center 12 communicatively coupled to a plurality of remote computers 14, via a communications network 16 such as the Internet. It will be appreciated by persons skilled in the art that any network such as a local area network (LAN), a wide area network (WAN), or a wireless system using, for example, a wireless application protocol (WAP), may be used. The resource center 12 may be implemented as a host computer, typically a server, to control the storage and retrieval of digital documents and to perform administrative functions for the system 10. The remote computers 14 are typically personal computers or work stations, however, those skilled in the art will appreciate that the invention can be practiced with other computer configurations, including hand-held devices, cell phones and microprocessor-based wireless information devices.

The host computer 12 and the remote computer 14 include a processing unit, computer readable medium including ROM, flash memory, non-volatile RAM, magnetic disk, optical disk, IC memory card or magnetic tape. The host computer 12 and the remote computer 14 executes an operating system such as Microsoft® Windows 2000, UNIX, EPOC, Pocket® PC OS or Palm OS ®. Computer operating systems frequently employ a graphical user interface to convey information to users via a monitor by various combinations of graphical items, including icons, text, drop-down menus, dialog boxes, and toolbars. A graphical user interface operates as part of the operating system and provides an interface to the operating system, and to application programs running in conjunction with the same, that allows users to access files and functions of the files. A user typically interacts with a graphical user interface by positioning a cursor over the graphical items with a mouse, or other input device, and actuating, or clicking, a button on the mouse.

Application programs including software modules and document modules are typically stored on the computer readable medium of the host computer 12 and the remote computer 14. Each document module on the host computer 12 and remote computer 14 is associated with a unique identifier including version information. The version information may include variables such as date and time, or an alpha, a numeric or an alphanumeric sequential system to define a chronological reference. The remote devices 14 may be logically coupled to each other or to the host computer 12 via a local area network (LAN) or a wide area network (WAN) 16. However, several resource centers 12 may be employed provided these resource centers 12 include the most recent document module as shown in FIG. 1 in an enterprise-wide environment.

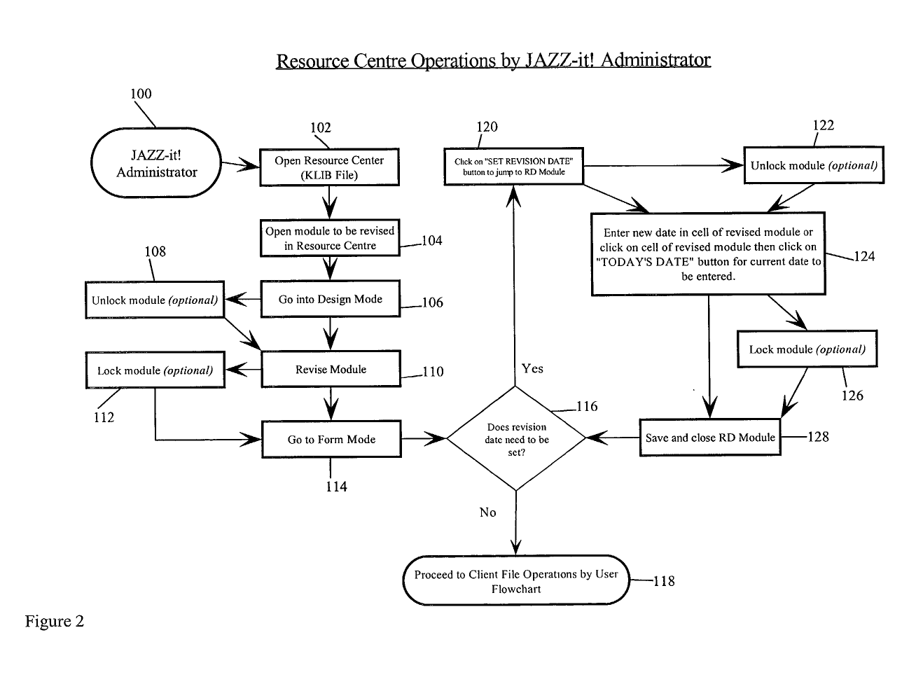

Reference will now be made to FIG. 2, which is a flow chart illustrating the steps a module version administrator performs to revise a document module. The administrator may perform the revisions for storage on the computer readable medium of the host computer via a remotely connected computer 14. In the preferred embodiment, the application program is CaseWare®, from CaseWare International Inc., Toronto, Canada. Briefly described, the CaseWare application program is a trial balance and work paper software, which includes integrated document management, write-up, report generation and links to other applications. However, it will be appreciated that the application program may be any application program that includes the use of templates such as spreadsheet, database applications, word processing or web publishing applications. Generally, the templates are designed to have their own unique format and industry and task-specific variables. For example, a restaurant template allows monitoring of inventory and sales levels, and includes final financial statements broken down by product category, including food and liquor. Whereas, a manufacturing industry template allows monitoring of purchases and expenses, with detailed schedules designed for manufacturing clients.

In this example, the process for revision of a financial statement module in the host computer 12 starts with step 100 with the administrator launching the CaseWare application including an add-on software module, and accessing the resource center in step 102. The add-on software module provides additional functions to the application program by facilitating the creating, editing and revising of document modules at the resource center 12 and updating the document modules at the remote computer. In the preferred embodiment, the add-on software module is JAZZ-it!® developed by AccountantsTemplates.com, Inc. of Calgary, Canada.

Generally, the application program window includes a toolbar disposed along the top of the screen display, although it may also be docked along a side or even may be free floating. The toolbars comprise a series of control buttons arranged along a bar and the buttons are each bound to an operation such that when a button is clicked with the mouse button, the bound operation is invoked. Typically, the administrator has administrative access rights to the application program on the resource center 12, and generally to all resources of system 10. In step 104, the administrator accesses the resource center 12 which includes a knowledge library (KLIB) having content and rules for generating audit reports, balance sheets, income statements, cash-flow statements and notes.

In step 106, the administrator initiates the ‘Design Mode’ in order to revise the module, in some instances the module may employ additional security measures, such as a challenge response, in step 108. Once the module has been unlocked, the administrator is able to revise the module in step 110. Upon completion of the revision of the module the administrator may secure the module with a challenge response or this action may be performed automatically by the system 10 on saving for storage on the computer readable medium. The next step 114, involves the administrator going into the ‘Form Mode’, and a determination is made as to whether a revision date needs to be set in step 116. Typically, the date may not need to be revised if the module has been revised within a predetermined time period, such as the same day. In step 118, the financial statement module is saved and stored on the computer readable medium.

Otherwise, should the date require changing then the ‘Revision Date’ module is initiated in step 120. As with the financial statement module, the revision date module may employ additional security measures, such as a challenge response, in step 122. Once the revision date module has been unlocked, the administrator may set the time-dependent variable, such as a revision date or revision time in step 124. Optionally, the administrator may secure the module with a challenge response in step 126 upon completion of the revision of the module, or this may be done automatically by the system 10. Upon completion of the revisions, the date module is saved in step 128 and the process ends with the financial statement module being saved and stored on the computer readable medium as in step 118.

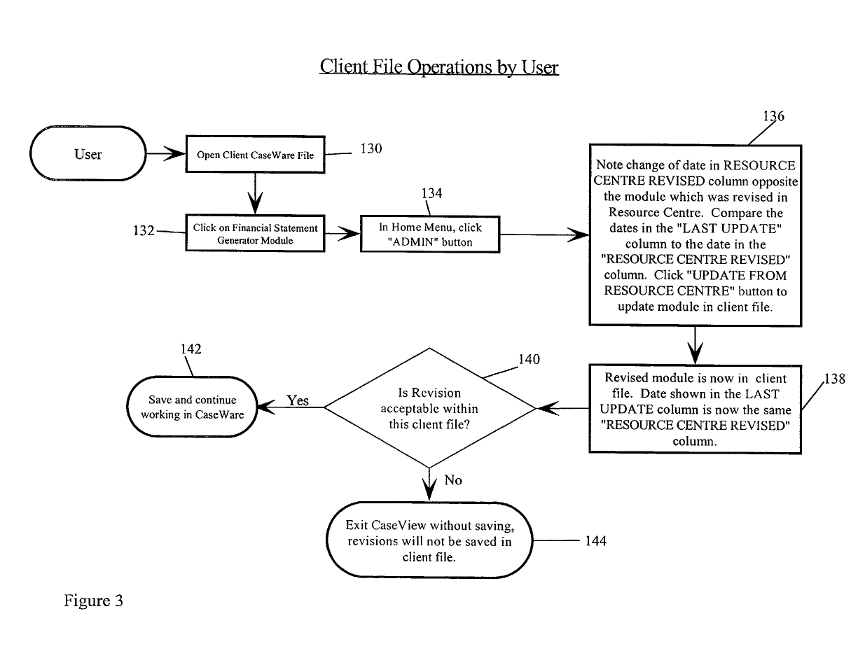

Now in order to illustrate the actions performed by a module version manager, typically a user at the remote computer, for the purposes of checking and updating a financial module, reference will now be made to FIG. 3. In the preferred embodiment, the user manages the modules at the remote computer in accordance with the version information of the modules. The process starts with the user accessing a CaseWare client file in step 130 and proceeds to step 132 in which the financial statement module generator is enabled. The financial statement generator produces any type of document, report or working paper, including generally accepted accounting principles (GAAP) financial statements. From the toolbar, the user selects the ‘ADMIN’ button, in step 134. Once enabled, the ‘ADMIN’ button displays information associated with the document file resident on the remote computer 14, in step 136. The presentation of the information may be included next to the document file or it may be presented to the user only when a mouse is moved over said document file. Such information may include the date and time of the last update of the document module, the date of the last revision and the location of the module in the resource center. The location of the document module may include the system name of the resource center, the IP address information, and the directory path or uniform resource identifier (URI). Also in step 136, the user may choose which resource center 12 to obtain the update from, in the event of resource outages or network congestion which may cause certain resource centers to be unavailable. Should there exist an updated module at the resource center 12, the user is alerted to that effect. If the user chooses to update the file then the remote computer 14 establishes a connection to the host computer 12 to access the updated financial statement module. In step 138, the revised module is incorporated into the client file.

A determination is made as to whether the revision is acceptable within the client file in step 140. If the revision 142 is acceptable, the document module is updated, however, if the revision is not acceptable then the revision is not saved in the client file and the module is rejected, in step 144.

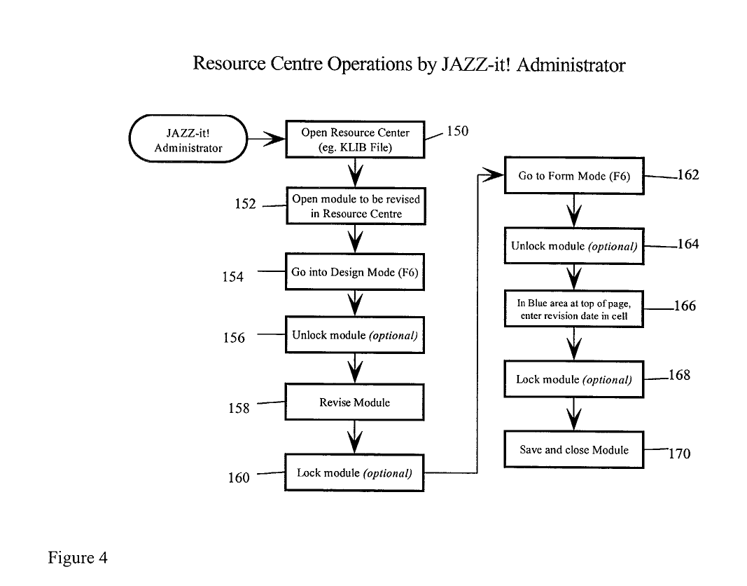

FIG. 4 is a flowchart showing the processes involved in the revision of working paper modules in the resource center 12. Working papers include spreadsheet and word processing features that link information such as accounts, lead schedule amounts, financial ratios and other elements to prepare customized reports and audit forms. The process for revision of a working paper module in the host computer 12 starts with an administrator launching the application program, and choosing an appropriate working paper module to revise in step 150 and step 152. In step 154, the administrator initiates the “Design Mode” in order to revise the module. In some instances the module may employ additional security measures, such as a challenge response, in step 156. Once the module has been unlocked, the administrator is able to revise the module in step 158. Optionally, the administrator may secure the module with a challenge response in step 160 upon completion of the revision of the module.

The next step 162, involves the administrator initiating the ‘Form Mode’, As with the working paper module, the revision date module may employ additional security measures, such as a challenge response, in step 164. Once the revision date module has been unlocked, the time variable may be set, such as the revision date or the revision time in step 166. Optionally, the administrator may secure the module with a challenge response in step 168 upon completion of the revision of the module, or this may be done automatically by the system 10. Upon completion of the revisions, the date module financial is saved and the process ends with the working paper module being saved and stored on the computer readable medium in step 170.

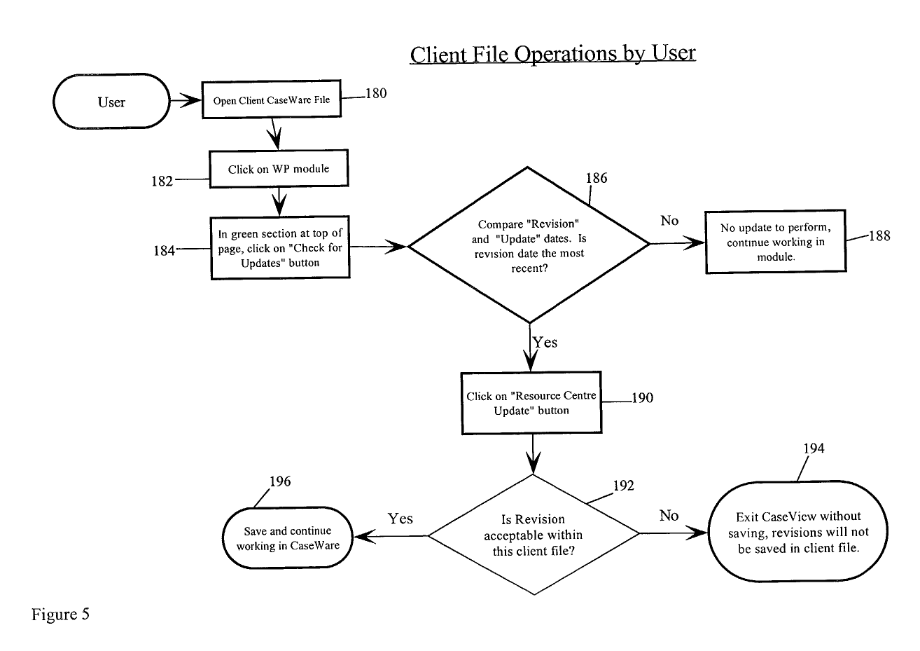

Now in order to illustrate the actions performed by a user for the purposes of checking and updating a working paper module, reference will now be made to FIG. 5. The process starts with the user accessing a CaseWare file in step 180 and proceeds to step 182 in which the working paper module is enabled. The working paper module allows changes to be made in the resource center 12 so that each client file is updated automatically, thus centralizing the revision process. Working papers included in the KLIB may include GAAP financial statements such as bank confirmations, long-term debt, income statement analysis, capital assets, and so forth. From the toolbar, the user selects a ‘Check for Updates’ button, in step 184. Once enabled, the status information associated with the document file resident on the user's remote computer 14 is displayed, in step 186. Also, a comparison of the revision and update dates is performed between the document file resident on the remote computer 14 and the corresponding document on the host computer 12. A determination is made as to whether a more recent document file exists on the host computer 12, if there is no need for an update then the process is terminated at step 188. Otherwise, in step 190 the user may choose which resource center 12 to obtain the update from, in the event of resource outages or network congestion, which may cause certain resource, centers to be unavailable. The remote computer 14 establishes a connection to the host computer 12 to access the updated working paper module.

A determination is made as to whether the revision is acceptable within the client CaseWare file in step 192. If it is still not accepted, the revisions are not saved and the module is rejected, in step 194, otherwise the working paper module is updated and the process ends with step 196 with the working paper module being saved and stored on the computer readable medium.

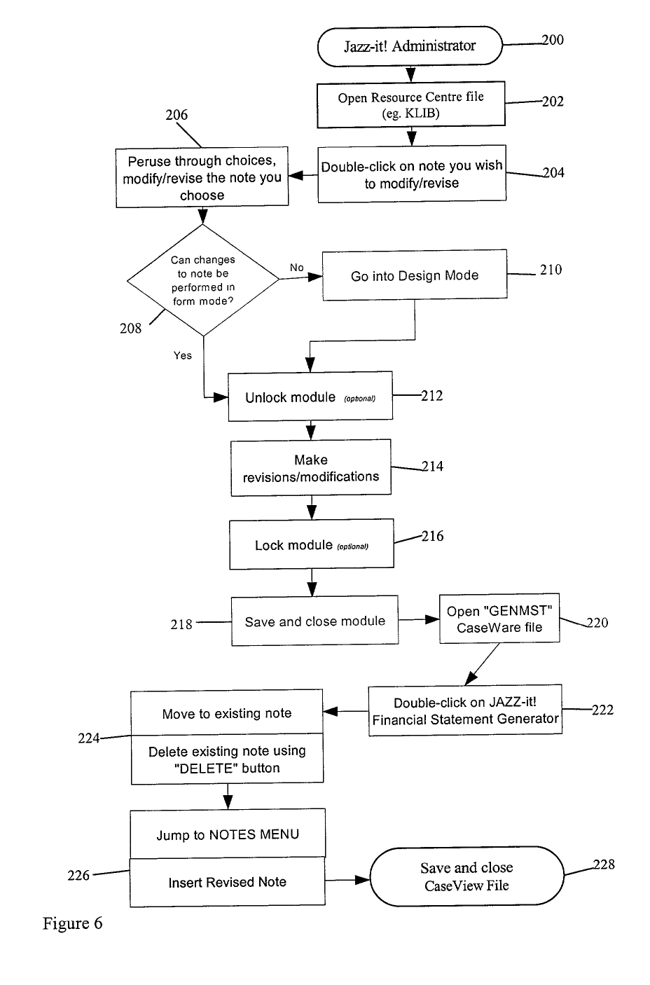

FIG. 6 is a flowchart showing the processes involved in the revision of note modules in the resource center 12. Note modules provide additional comments such as highlights or outcome of a phone conversation with a client. The system may include standard notes such as short-term debt, discontinued operations, lease commitments, share capital, accounting change and joint venture operations. The notes are thus maintained as part of the client master record. The process for revision of a note module in the host computer 12 starts with step 200 with an administrator launching the CaseWare application program for revising the note module to be revised in step 202 and step 204. The administrator accesses the resource center 12 and in step 204, the note to be revised is chosen and a determination as to whether the changes can be performed in ‘Form Mode’ is made, if the changes can not be performed in ‘Form Mode’ then the administrator initiates the ‘Design Mode’, otherwise the process proceeds to step 210.

In some instances the module may employ additional security measures, such as a challenge response, in step 210. Once the module has been unlocked, the administrator is able to revise or modify the note module in step 212. Optionally, the administrator may secure the module with a challenge response in step 214 upon completion of the revision of the module, or this may be done automatically by the system 10. Upon completion of the revisions, the note module is saved and the note module is saved and stored on the computer readable medium in step 216.

Once the note module has been saved and closed, any CaseWare file that needs a note to be added is opened in step 218, and the financial statement generator is enabled in step 220. The existing note is deleted in 222 and the new note is inserted in step 224. Upon completion of the addition, the CaseWare file is saved and stored on the computer readable medium in step 226.

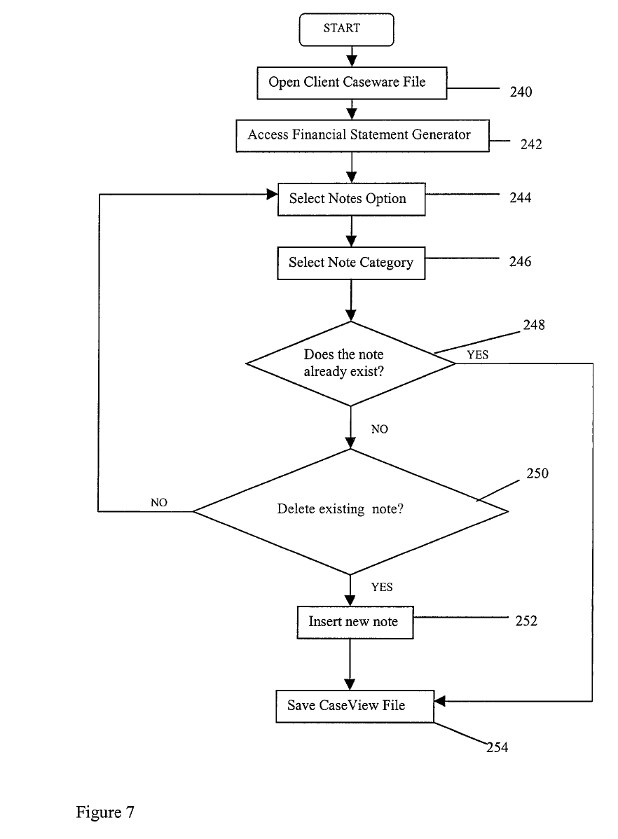

Now in order to illustrate the actions performed by a user for the purposes of checking and updating a note module in the client files, reference will now be made to FIG. 7. The process starts with the user accessing a CaseWare file in step 240 and proceeds to step 242 in which the financial statement module generator is enabled. From the toolbar the user selects the ‘Notes’ option, in step 244. Once enabled, the ‘Notes’ option displays a plurality of notes that can be selected from a drop-down list in step 246. Once the note has been selected a determination as to whether the selected note already exists is made in step 248. If the note does exist, no further steps are taken and the process terminates with step 254. However, if the note exists then another determination is made as to whether to keep the existing note or replace it with the selected note in step 250. The new note is inserted from the drop-down list into the client file in step 252. Upon completion of the addition of the note, the client file saved in step 254.

In another embodiment, the unique identifier may include, for example, alphanumeric schemes including dates, Boolean values, and the like.

In yet another embodiment, the documents may include letters and other forms may include dynamic links to financial statement documents, and may be revised by an administrator and may be updated by a user with the method similar to the methods described above. Typically, the letters may include an engagement letter, a client enclosure letter, or a bank confirmation instruction letter.

The above-described embodiments of the invention are intended to be examples of the present invention and alterations and modifications may be effected thereto, by those of skill in the art, without departing from the scope of the invention which is defined solely by the claims appended hereto.

The embodiments of the invention in which an exclusive property or privilege is claimed are defined as follows:

1. A method for updating a module from a host computer to remote computer, said module being stored on a computer readable medium, the method including the steps of:
associating said module with a unique identifier including version information of said module;
establishing a communications connection between said host computer to and said remote computer;
comparing version information of said module on said host computer to and version information on said remote computer;
transmitting said module to said remote computer when said module on said host computer supersedes module on said remote computer in accordance with said version information.

2. The method of claim 1, wherein said version information includes time-dependent variables such as date and time.

3. The method of claim 1, wherein said version information is associated with time-dependent variables having alpha, numeric and alphanumeric variables.

4. The method of claim 1, wherein at said remote computer the method of comparing the version information further includes the steps of:
displaying the version information of said module on said remote computer, said version information including a time-dependent variables indicating occurrence of update and of revision of said module;
determining whether there is a difference between said time-dependent variables indicating occurrence of update and of revision of said module.

5. The method of claim 1, wherein the steps of updating modules includes the further steps of managing changes of said document modules for use within an application program, said step of managing said changes including the steps of:
maintaining host document modules in a computer readable medium at the host computer,
providing alerts to a user in the event of a host document module revision,
comparing said host document module with a remote document module on said remote computer; and
selectively incorporating changes in host document module to said remote document module in accordance with said comparison.

6. A system for updating documents, the system having an application program and an add-on software module characterized by adding additional functions to said application program, the system including:
a resource center for managing document modules for use with said application program, said resource center communicatively coupled to a plurality of remote computers, said remote computers being configured to receive document modules from said resource center;
a version administrator for creating, editing and revising said document modules at the resource center in accordance with said functions afforded by said add-on software module; and
a version manager at the remote computer for checking and comparing said version information of the module thereon with said version information of the module at the resource center and initiating said updating of said document modules at said remote computer in accordance with said functions afforded by said add-on software module and to said comparison.
